(19) United States
(12) Patent Application Publication
(10) Pub. No.: US 2002/0086137 A1
(43) Pub. Date: Jul. 4, 2002

(54) Method of reducing wafer stress by laser ablation of streets

(75) Inventors: Donald W. Brouillette, St. Albans, VT (US); Robert D. Dostie, Jeffersonville, VT (US); Petra U. Klinger-Park, Jericho, VT (US)

Correspondence Address: Robert A. Walsh, IBM Corporation, Intellectual Property Law Dept. 972E, 1000 River Road, Essex Junction, VT, 05452, US

(73) Assignee: International Business Machines Corporation, Armonk, NY (US)

(21) Appl. No.: 09/751,018

(22) Filed: Dec. 28, 2000

(51) Int. Cl. B32B 3/10

(52) U.S. Cl. 428/138

(57) ABSTRACT

A wafer is diced by non-abrasively forming a groove along at least one dicing channel without removing any materials as hard as diamond; optionally thinning the wafer by backside grinding and cutting through the wafer by sawing along the groove.

### FIELD OF THE INVENTION

The present invention relates generally to the fabrication of integrated circuits, and particularly, but not by way of limitation, to dicing wafers into chips and to methods of reducing the stress applied to semiconductor wafers during the process of chip formation.

### BACKGROUND

Since the development of integrated circuit technology, computers and computer storage devices have been made from wafers of semiconductor material comprising a plurality of integrated circuits. After a wafer is made, the circuits are typically separated from each other by dicing the wafer into small chips. Thereafter, the individual chips are bonded to carriers of various types, interconnected by wires and are packaged. The manufacturing steps for semiconductor devices are generally classified into steps for patterning various semiconductor elements in a wafer (semiconductor substrate) and steps for dicing the respective semiconductor elements formed in the wafer into chips and sealing the chips in packages. Recently, the diameter of a wafer has been increased to reduce the manufacturing cost, and there has been a demand for a decrease in size and thickness of packages in order to enhance the packaging density. In the prior art, in order to seal a semiconductor chip in a thinned package, a bottom surface of a wafer, which is opposite to a pattern formation surface (major surface) of the wafer, is lapped by a grindstone and polished by free grind grains to thin the wafer prior to dicing the wafer into chips. Then, the wafer is diced. At the time of lapping, an adhesive sheet or a resist is coated to the pattern formation surface of the wafer in order to protect the pattern formation surface. Thereafter, grooves are formed in dicing line areas provided on the major surface of the wafer. These grooves are formed by means of a diamond scriber, a diamond blade, a laser scriber, etc. The dicing step is carried out by a half-cut method in which the wafer, as a single body, is diced to ½ of the thickness of the wafer or diced until the remaining wafer becomes about 30 μm thick; a half-cut method in which the wafer is diced similarly, with an adhesive sheet attached to the bottom surface of the wafer; or a full-cut method in which the wafer is diced throughout the thickness thereof while the adhesive sheet is cut to a depth of 20 to 30 μm. The half-cut method requires another dividing step. When the wafer, as a single body, is used, the wafer is sandwiched between soft films, and an external force is applied by a roller or the like, thus dividing the wafer. When the wafer is attached to the adhesive sheet, an external force is applied on the sheet, thus dividing the wafer. The divided chips are separated from the sheet in the following manner. The bottom surface of the sheet is pushed up by a pickup needle provided on a die bonding device. The needle penetrates the sheet and comes in direct contact with the bottom surface of each chip. The needle is further raised and the chip is separated from the sheet. The surface of the separated chip is held by a tool called “collet” and the chip is mounted on an island of a lead frame. Then, the pads of the chip are electrically connected to inner lead portions of the lead frame by means of wire bonding, and the chip is sealed in a package. The chip may be mounted on the island, for example, by a method in which a conductive paste is coated on the island in advance, a method in which a gold-silicon eutectic is used, or a method in which a thin film is deposited on the bottom surface of the wafer and the chip is mounted by using solder.

The above-described wafer dividing method and semiconductor device manufacturing method, however, have the following problems (a) to (c).

(a) The wafer tends to be broken while it is thinned by lapping. Even if the wafer is lapped with the protection tape being attached, the wafer may warp due to distortion in the lapping. As a result, the wafer may be caught during transfer within the lapping apparatus and may be broken. Since the strength of the wafer decreases as the thickness of the wafer decreases or the diameter thereof increases. If the wafer body, after it is thinned, is transferred for various processes as in the prior art, the possibility of breakage increases.

For example, when the wafer is 400 μm thick, it can withstand a load of about 1.6 Kgf/mm². However, if the thickness is decreased to 200 μm, the breaking strength of the wafer decreases to ¼ or 0.4 Kgf/mm²,

(b) Since the two sheets, one for protecting the pattern formation surface and the other for fixing the wafer at the time of dicing, are used, the attaching and separating steps for the two sheets are required. Consequently, the cost for material increases and the number of manufacturing steps also increases.

(c) The degree of chipping on the bottom side of the wafer increases when the wafer is diced, resulting in a decrease in the breaking strength of the chip.

The semiconductor devices and metallized circuitry formed on the wafer are provided protection in the form of passivation and other protective film layers. These films tend towards states of tension or compression. When wafers are thinned, the tensile and compressive forces tend to warp the wafer. This tendency becomes more severe as the wafer is processed to increasing degrees of thinness. After backside grinding, to thin the wafer, a saw blade separates the individual chips. At this stage various torques cause twisting and cracking of the chips resulting in decreased yields.

Cracking causes production losses by at least two mechanisms. Acute failure is induced promptly by mechanical damage. In addition, chronic failure can result where cracks, insufficient to cause immediate mechanical failure, induce failure by permitting air and moisture to migrate past the protective films. In this mode, corrosion of the metallic circuitry and corrosion-induced migration of copper causes failure.

The present invention addresses these problems. Other objects and advantages will become apparent from the following disclosure.

### SUMMARY OF INVENTION

The invention provides a method for dicing wafers into chips and methods of reducing the stress applied to semiconductor wafers during the process of chip formation. The method comprises the steps of:

providing a wafer comprising semiconductor material having a front surface and a back surface and having at least one dicing channel defined on the front surface;

non-abrasively forming a groove along the at least one dicing channel without removing any materials as hard as diamond;

optionally thinning the wafer by backside grinding and

cutting through the wafer by sawing along the groove.

The method provides that the groove is formed by laser ablation down to or slightly into the semiconductor substrate.

The method provides that optionally, a protective coating is applied to the wafer prior to the inventive processing. This coating will be sealed along the side of the chip by the process of laser ablation providing a barrier against the entry of air and moisture. The present invention simplifies BEOL (Back End Of the Line) fabrication because it does not require special BEOL processing to create crack stop structures. BEOL fabrication is also simplified in that the present invention eliminates the requirement for first incorporating and then etching crack stop metals. The present invention also eliminates the additional processing steps and mask sets required.

The present invention provides for the removal of multiple layers of organic insulator and inorganic passivation layers using a single laser ablation process step.

The invention provides for the passivation of exposed edges of the organic dielectric material in order to prevent the diffusion of oxygen and of moisture into the Cu features.

The invention provides semiconductor devices fabricated by the disclosed methods.

The invention provides chips having characteristic saw striations and laser markings.

Still other objects and advantages of the present invention will become readily apparent by those skilled in the art from the following detailed description, wherein it is shown and described preferred embodiments of the invention, simply by way of illustration of the best mode contemplated of carrying out the invention. As will be realized the invention is capable of other and different embodiments, and its several details are capable of modifications in various obvious respects, without departing from the invention. Accordingly, the description is to be regarded as illustrative in nature and not as restrictive.

### BRIEF DESCRIPTION OF DRAWINGS

The invention is best understood from the following detailed description when read in connection with the accompanying drawing. It is emphasized that, according to common practice, the various features of the drawing are not to scale. On the contrary, the dimensions of the various features are arbitrarily expanded or reduced for clarity. Included in the drawing are the following figures:

FIG. 1 illustrates a wafer having ICs separated by a channel; and

FIGS. 2-4 illustrate details of processing steps.

### DETAILED DESCRIPTION OF A PREFERRED EMBODIMENT

Reference is made to the figures to illustrate selected embodiments and preferred modes of carrying out the invention. It is to be understood that the invention is not hereby limited to those aspects depicted in the figures.

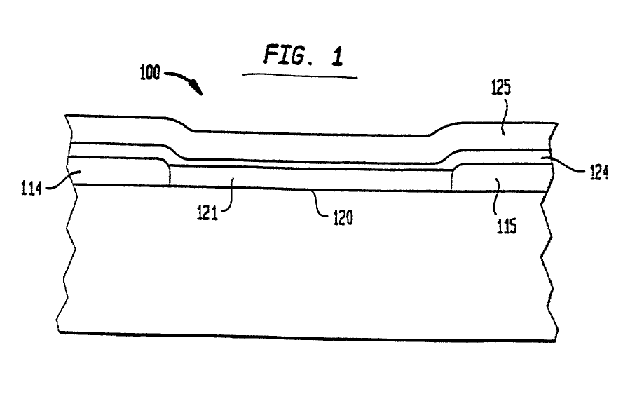

Referring to FIG. 1, a portion of a wafer 100 is depicted. Illustratively, the wafer comprises ICs 114 and 115 separated by a channel 120. Channel 120 is the area in which the dicing tool cuts or scribes to separate the ICs. The width of the channel is, for example, about 100 microns (μm). Typically, the channel is covered with a dielectric layer 121, such as silicon dioxide. The surface of the wafer is covered with hard and soft passivation layers 124 and 125, respectively. The hard passivation layer, for example, comprises silicon dioxide or silicon nitride and the soft passivation layer comprises polyimide. The passivation layers serve to protect the surface of the ICs. Prior to wafer dicing, the passivation layers in the channel are typically removed, leaving a portion of the dielectric layer of the metallization.

As the dicing tool cuts or scribes the wafer, cracks and chips result. Due to the properties of the typical dielectric layer, cracks propagate from the area where the dicing tool cuts the wafer. Cracks in excess of a few microns in depth and several tenths of millimeters in length have been observed. In some instances, such cracks can extend from the cutting edge into the active chip areas, causing significant reliability degradation in the resulting ICs. This decreases the yield of ICs per wafer.

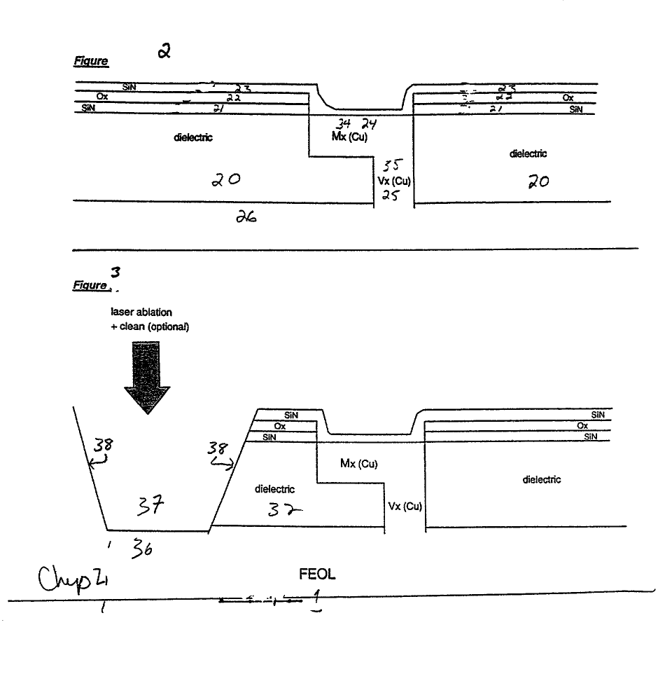

With reference to FIG. 2, what is shown is the kerf region of a die prior to ablation of a channel and slicing into chips. The kerf region is variously termed streets or alleys. A dielectric layer 20, associated with the BEOL structure, is shown over the FEOL structure 26. The dielectric layer is typically an organic material such as SiLK (Trademark of Dow Chemical Company). Also shown is the copper wiring typical of BEOL structures including a copper via 25 and copper level wiring 24. The BEOL structure is typically finished with layers of silicon nitride 21, a silicon dioxide layer 22, and a second silicon nitride layer 23.

Turning to FIG. 3, a groove 37 is shown having been formed in the kerf area of the wafer. The plurality of dies comprising the wafer are ultimately sliced into individual chips by passing a saw through a plurality of such grooves. Formation of the groove pattern can be done by, but is not limited to, 1×projection of the ultraviolet light or CO₂ laser.

The ultraviolet light source in this invention can be a range of eximer Lasers from xenon fluoride or argon fluoride, but not limited to these. The base silicon of the FEOL structure acts as stop for the laser ablation process. Typically the base silicon is ablated to a depth of about 40 microns or more if needed, but normally only the removal of films to the semiconductor substrate is required.

The laser-ablated groove 37 is typically wider near the top edge than near the bottom edge. The groove has walls 38, typically, these walls do not rise in parallel, but diverge. Thus, the cross-section of groove 37 is substantially trapezoidal.

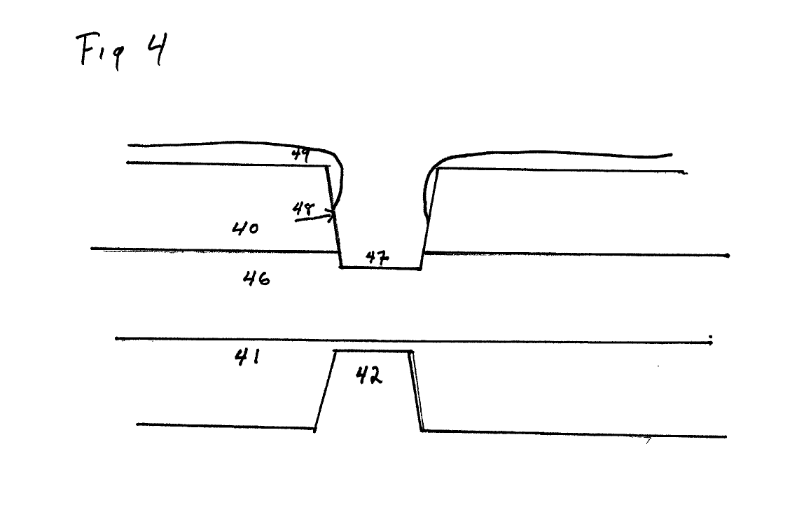

Turning now to FIG. 4. Typically, a wafer is provided a protective coating 49 layered over the BEOL structures defined on the wafer. The function of the protective layer is to insulate the devices against air and moisture. Towards the bottom of groove 47 protective coat 49 is substantially ablated away, but towards the top, coating 49 is partially melted and flows along the groove wall 48 sealing the chip against the diffusion of air or moisture. The wafer is diced yielding individual chips by sawing along grooves 47. The sawing is conventional to the art and need not be described herein in any detail.

Optionally, it may be desired to thin the wafer prior to dicing into chips. Where thinning is desired, a backside grind step may be performed after formation of groove 47 and prior to dicing. Backside grinding is known in the art and is discussed in, for example Sasaki et al (U.S. Pat. No. 5,888,883) the entire contents of which are hereby incorporated by reference. Where thinning is optionally selected, stress on the wafer may be further reduced by forming grooves 42 on the backside of the wafer prior to the grinding step. Grooves 42 may be formed by laser ablation similar to the formation of grooves 47.

It will, therefore, be appreciated by those skilled in the art having the benefit of this disclosure that this invention is a method for forming a crack stop structure and diffusion barrier in integrated circuits. Moreover, it will be realized that the invention is capable of producing integrated circuits so protected. Although the illustrative embodiments of the invention are drawn from the semiconductor arts, the invention is not intrinsically limited to that art. The foregoing description of the invention illustrates and describes the present invention. Additionally, the disclosure shows and describes only the preferred embodiments of the invention but, as mentioned above, it is to be understood that the invention is capable of use in various other combinations, modifications, and environments and is capable of changes or modifications within the scope of the inventive concept as expressed herein, commensurate with the above teachings and/or the skill or knowledge of the relevant art. The embodiments described hereinabove are further intended to explain best modes known of practicing the invention and to enable others skilled in the art to utilize the invention in such, or other, embodiments and with the various modifications required by the particular applications or uses of the invention. Accordingly, the description is not intended to limit the invention to the form disclosed herein. Also, it is intended that the appended claims be construed to include alternative embodiments.

We claim:

1. A method of dicing a wafer comprising:
a) providing a wafer comprising semiconductor material having a front surface and a back surface and having at least one dicing channel defined on said front surface;
b) non-abrasively forming a groove along said at least one dicing channel without removing any materials as hard as diamond; and
c) cutting through said wafer by sawing along said groove.

2. A method of dicing a wafer, according to claim 1, wherein said groove is formed by laser ablation.

3. A method of dicing a wafer, according to claim 1, further comprising the step of grinding said back surface of said wafer between steps (b) and (c).

4. A method of dicing a wafer, according to claim 1, wherein said wafer further comprises layers of insulation and metal and wherein said groove is formed through said layers.

5. A method of dicing a wafer, according to claim 1, and wherein said groove is formed partially through said semiconductor material.

6. A method of dicing a wafer, according to claim 1, wherein said wafer further comprises second dicing channels defined on said back surface and wherein the method further comprises the step of forming a groove along said second dicing channels after said grinding step and before said sawing step.

7. A method of dicing a wafer, according to claim 1, wherein said wafer further comprises a protective coating.

8. A semiconductor chip, fabricated according to the method of claim 1, comprising a top surface and at least one sidewall having a first portion proximal to said top surface and a portion distal to said top surface wherein said distal portion has striations from a saw.

9. A semiconductor chip, according to claim 1, wherein said proximal portion has marks indicating a laser scribe.

10. A semiconductor chip, according to claim 1, further comprising a passivation film on said top surface wherein said passivation film is sealed along said chip sidewall.
